(19) United States
(12) Patent Application Publication
(10) Pub. No.: US 2022/0347819 A1
(43) Pub. Date: Nov. 3, 2022

(54) Two Hose Cryogenic/Abrasive Blasting System

(71) Applicant: Precision Iceblast Corporation, Peshtigo, WI (US)

(72) Inventors: Keith R. Boye, Hobart, WI (US); Matthew D. Peterson, Pulaski, WI (US)

(21) Appl. No.: 17/735,665

(22) Filed: May 3, 2022

Related U.S. Application Data
(60) Provisional application No. 63/183,136, filed on May 3, 2021.

(51) Int. Cl. B24C 1/00; B24C 7/00; B08B 7/00

(52) U.S. Cl. CPC B24C 1/003; B24C 7/0046; B08B 7/00; B24C 3/06

(57) ABSTRACT

Systems and methods for cleaning and preparing a surface are described. The system includes a housing with a first hopper configured to receive a first material and a second hopper configured to receive a second material. A tube housing an auger may be located where the two hoppers meet. In this way, the materials are mixed in the tube before being pushed through a hose to a nozzle. The mixture can be sprayed out of the nozzle. The mixture only requires a single air source, and the system operates using a combination of gravity, venturi suction, vibration, an auger and the like.

### CROSS-REFERENCE TO RELATED APPLICATION

This application claims the benefit of U.S. provisional patent application Ser. No. 63/183,136 filed May 3, 2021 and titled Two Hose Cryogenic/Abrasive Blasting System, the entire disclosure of which is hereby incorporated by reference.

### BACKGROUND OF THE INVENTION

### 1. Field of the Invention

The invention relates generally to industrial cleaning equipment and associated methods and, in particular, to equipment used to improve the ease with which industrial machinery can be cleaned. The invention similarly relates to surface preparation.

### 2. Discussion of the Related Art

Surface blasting has been used to clean a variety of surfaces using different materials, for instance, water, ice, steam, cleaning solution, dry ice, sand, glass, and many other materials. Surface blasting can be used for cleaning of various industrial equipment, as well as preparing various surfaces for painting or other treatments. For instance, surface blasting can be used to remove previous loose paint so that the surface is prepared to accept a new paint job and bond with the new layers of paint.

Some of the materials that have been used for surface blasting have undesirable effects on the surface that is being cleaned or prepared. For instance, use of water or steam can be disadvantageous because it can cause corrosion, decrease the substrate life, cause slippery conditions, and increase humidity. Additionally, water or steam involves high conductivity, and it can result in generation of hazardous waste, while also not killing all micro-organisms. Use of sand also has a number of negative consequences, including the decrease in substrate life, high conductivity, and generation of hazardous waste. Further still, sand can embed micro-organisms and debris into the substrate, and large containments are needed.

Additionally, some surface blasting treatments combine multiple materials to achieve desirable results. However, these systems require multiple air source connection lines that deliver products to a nozzle where the materials are combined and dispelled from the nozzle.

Further still, most systems in the prior art only allowed for cryogenic cleaning or abrasive media cleaning, rather than a blended approach, Some systems include multiple separate hoppers that are joined together using complicated systems including multiple air lines or devices that require multiple trigger systems, These systems oftentimes resulted in inconsistent mixing of the materials.

An exemplary system of the prior art is shown in FIG. 7. As can be seen, the system includes a compressor that delivers air through a machine to a handle. This allows a single material to be sprayed out of the handle.

Many of these concerns are alleviated using dry ice or other materials or a blend of multiple materials. Nevertheless, further improvements are also desired.

What is needed is a blasting system that can clean and prepare surfaces as outlined above, What is further needed is machinery that enables the blasting system to efficiently blend multiple materials and blast the mixture in order to clean and prepare surfaces. What is further needed is a machine that achieves SP1, SP2, SP3, SP5, SP6, SP7, SP10, SP11, SP12, SP13, and SP14 surface preparation standards for cleaning and protective coatings. What is also needed is a machine that achieves Nace 1, 2, 3, 4, 5, 6, and 8 standards. What is also needed is a system where the materials are blended in a single piece of equipment with one operating trigger system in order to reduce the equipment footprint, and simplify the overall construction.

### SUMMARY AND OBJECTS OF THE INVENTION

By way of summary, the present invention is directed to a cleaning system for mixing various cleaning materials into a mixture and then spraying the mixture to clean or prepare a surface. The system may include a housing, at least one hopper contained within the housing, an air source connected to the housing, a hose extending from the housing, and a nozzle attached to the hose. The housing could include at least two hoppers, for instance, a first hopper configured to receive a cryogenic material and a second hopper configured to receive an abrasive media. These first and second hoppers may be positioned to mix the cryogenic material and the abrasive material. The system may further comprise a grate located at an entrance of the first hopper. The grate may be configured to minimize the clumping of material deposited into the first hopper. The system may further include a cover that is configured to cover the entrance of the first hopper. The system may also further include a tube configured to mix the cryogenic material and the abrasive material. An auger may extend along a portion or all of the tubing. The hose may be attached to the tubing. The system may further include a vibrator to encourage movement of the cryogenic material and the abrasive material. The system may also include a plurality of flow valves.

Additionally the system may be configured to achieve specific standards. For instance, the system could result in blasting material that can achieve SP1, SP2, SP3, SP5, SP6, SP7, SP10, SP11, SP13, SP14 surface preparation standards for cleaning and protective coatings. The system may also be recognized by Nace standards of Nace 1, 2, 3, 4, 5, 6, and 8. Additionally, the system may be gravity fed and the system may have a venturi suction.

According to another aspect of the present invention, a method of using a cleaning system is provided. The method may include the steps of depositing a first material into a first hopper, transferring the material through a hose to a nozzle, and dispelling the material through the nozzle to clean or prepare a surface. The method may also include the steps of depositing a second material into a second hopper and mixing the first material with the second material. The method may also include the steps of activating an auger to mix the materials in a tube and transferring the mixed materials from the tube to a hose. The method may also include the step of moving the mixture using one or more of gravity, a venturi suction, and vibration forces.

These, and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 illustrates a first perspective view of the inventive two hose cryogenic/abrasive blasting system;

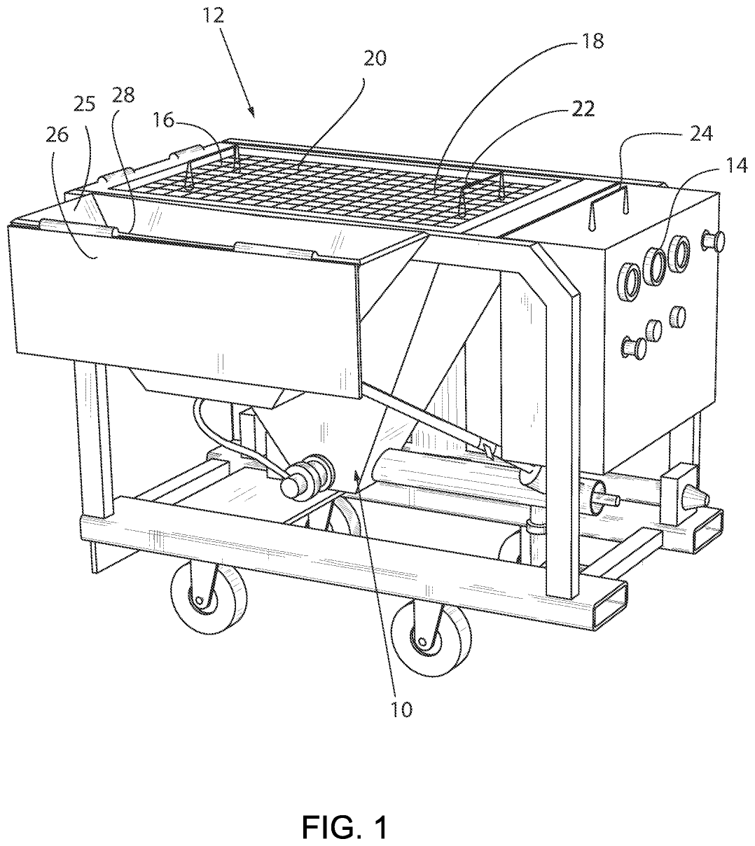

FIG. 2 illustrates a second perspective view of the inventive two hose cryogenic/abrasive blasting system;

FIG. 3 illustrates a third perspective view of the inventive two hose cryogenic/abrasive blasting system;

FIG. 4 is a schematic view of the system of FIGS. 1-3;

FIG. 5 is a schematic view of another system of FIGS. 1-3;

FIG. 6 is a schematic view of another system of FIGS. 1-3; and

FIG. 7 is a schematic view of a PRIOR ART system.

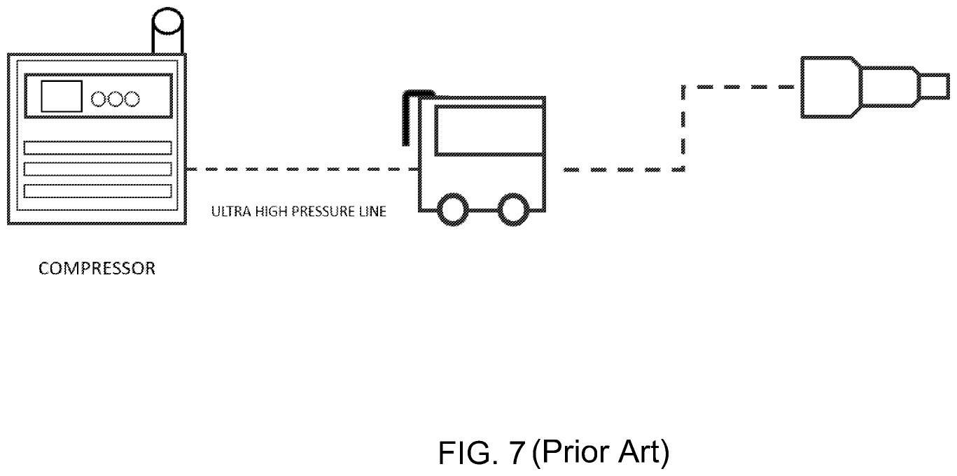

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word connected, attached, or terms similar thereto are often used. They are not limited to direct connection but include connection through other elements where such connection is recognized as being equivalent by those skilled in the art.

### DESCRIPTION OF PREFERRED EMBODIMENTS

The present invention and the various features and advantageous details thereof are explained more fully with reference to the non-limiting embodiments described in detail in the following description.

A two hose cryogenic/abrasive blasting system 10 for cleaning and preparing surfaces is generally shown in the figures. The system 10 is equipped with various containers or hoppers, tubing, valves, regulators, and the like, to enable efficient mixing of multiple substances, after which the mixture is transported to a nozzle/sprayer gun, and then sprayed about various surfaces and equipment. These components can be opened and closed in order to mix and combine that various materials in different proportions as will further be described. Many of these components will be more thoroughly described below.

The system 10 achieves surface cleaning and surface preparation standards that traditional cryogenic cleaning systems could not have achieved due to the nature of cryogenic cleaning The system 10 allows cryogenic cleaning to occur to achieve surface preparation standards that only abrasive blasting means have been able to achieve in the past. As result, the system 10 reduces abrasive media usage, reducing disposable debris and reducing the waste footprint.

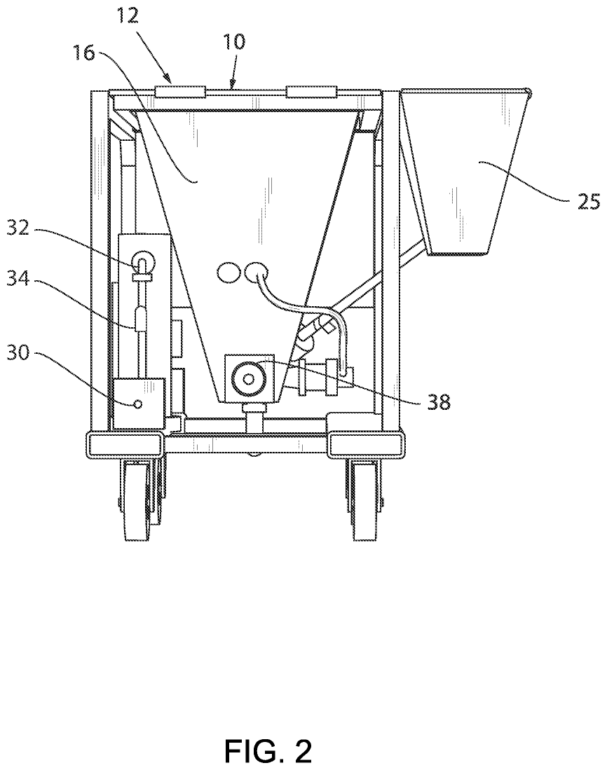

The system 10 includes a housing 12. The housing 12 is made of a durable material, as shown in the figures of stainless steel, although other materials could be used. The housing 12 includes a control panel 14 having various dials and controls that can be manipulated to control use of the system 10. The housing 12 has a primary hopper 16 having a large opening 18 that extends along the top of the housing 12. As best seen in FIG. 2, the hopper 16 is generally funnel-shaped in order to encourage materials contained therein to move downwardly. The large opening 18 may be covered by a removable grate 20. The removable grate 20 includes multiple handles 22 to allow the grate 20 to easily be removed and reinstalled. The grate 20 is configured to allow materials to pass through the grate 20 while preventing clumping of the materials. Additionally, a cover (not shown) can be placed on top of the grate 20 and/or directly on top of the opening 18 to prevent materials, such as rain, snow, and the like, from entering the hopper 16. The top of the housing 12 also has a handle 24 to enable movement of the housing 12 from project to project.

Additionally, a second hopper 25 is provided. As shown, the second hopper 25 is located at the side of the housing 12. The second hopper 25 is smaller in size relative to the primary hopper 16. Of course, the hoppers need not be limited to the sizes and shapes shown in the figures, and instead could vary significantly depending on the desire of a user, the quantity of materials being mixed, the overall size of the system 10, and any other relevant factors. As shown, the second hopper 25 does not include a grate, although one could be provided in certain embodiments. The second hopper 25 has a cover 26 which can be pivoted to cover the opening 28 located at the top of the hopper 25. While a permanently installed cover 26 that is pivotable about a hinge is shown, the cover 26 could similarly be removable.

As shown, the first hopper 16 is configured to receive a dry ice mixture, More specifically, dry ice can be poured over the grate 20 and into the hopper 16. This configuration including the grate 20 is beneficial in that it helps to prevent clumping of the dry ice when it is poured into the hopper 16. The second hopper 25 is configured to receive a second material that is mixed with the dry ice. For instance, the second material could be any abrasive material.

Advantageously, the system 10 only requires a single main air source connection, as shown in the form of an air compressor 50. The air compressor 50 directly feeds the multifunctioning blasting hopper system 10. The single main air source connection connects to a nipple 30 formed in a pipe 32 of the system 10 as can be seen in FIG. 2. A handle 34 can be rotated to enable or disable flow of air into the system 10.

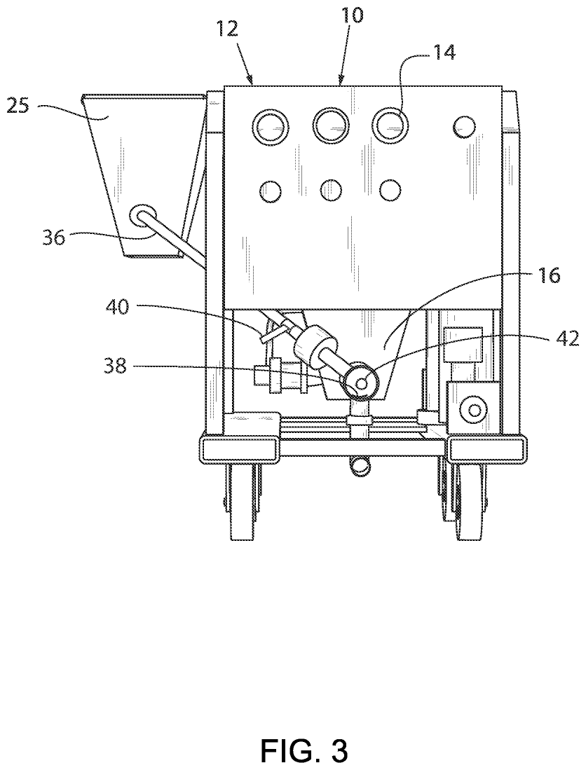

Turning to FIG. 3, the various pipes that deliver the materials can more easily be seen. An abrasive hopper tubing 36 is shown that delivers abrasive material from the second hopper 25 to a delivery tube 38. A control valve 40 is located along the tubing 36 to enable or disable flow of the abrasive material into the delivery tube 38. The control valve 40 can also incrementally be adjusted in order to vary the quantity of abrasive that enters the delivery tube 38. For instance, the control valve 40 could be partially opened to allow for a partial supply of abrasive or it could be completely opened to allow a maximum quantity of abrasive material to be supplied. As shown, the delivery tube 38 has a diameter of approximately 2 inches, although larger and smaller tubes may be used based on a number of factors, including but not limited to the flow rate. Additionally, dry ice is fed down the hopper 16 into the delivery tube 38 using an auger 42 that runs along the length of the hopper 16. A hose 44 extends from the delivery tube 38 to a sprayer gun 46. The mixed media is transported along the hose 44 and out the sprayer gun 46 to clear or blast any surfaces. When a trigger is pulled on the sprayer gun 46, the auger 42 is activated. Because of the specific orientation of the components, consistent mixing the of the materials can be achieved. Furthermore, because of the orientation of the various components relative to one another, the overall footprint of the system 10 can be minimized to make it easier to move the system 10 from location to location.

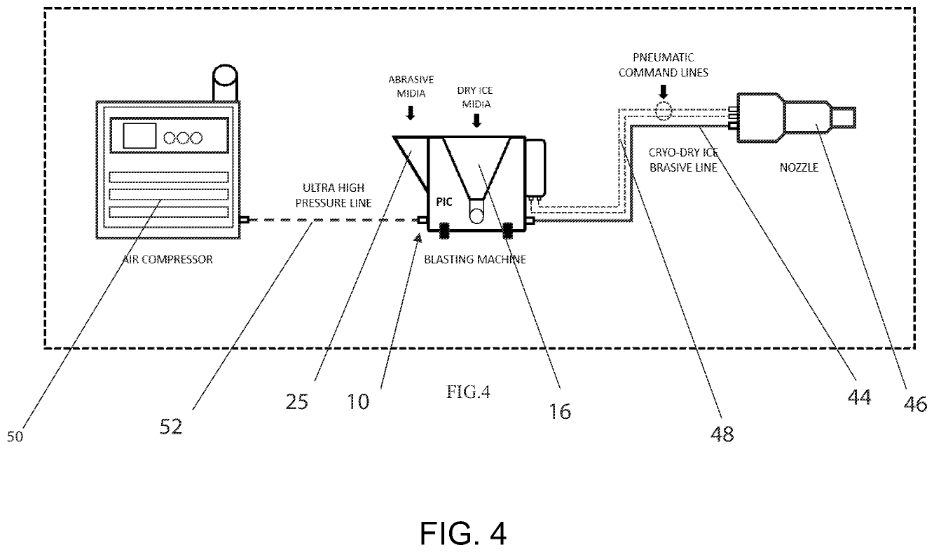

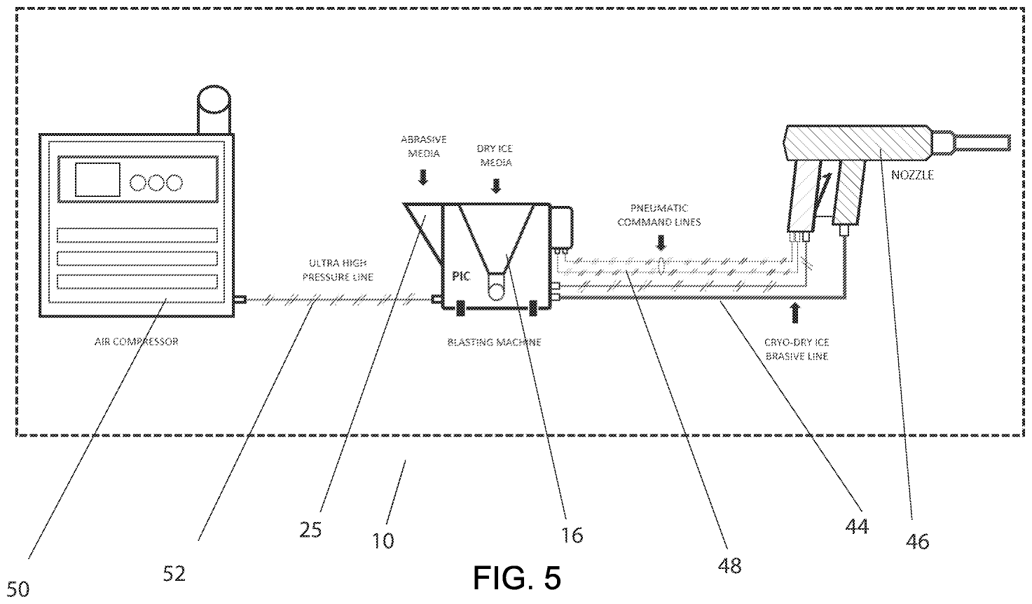

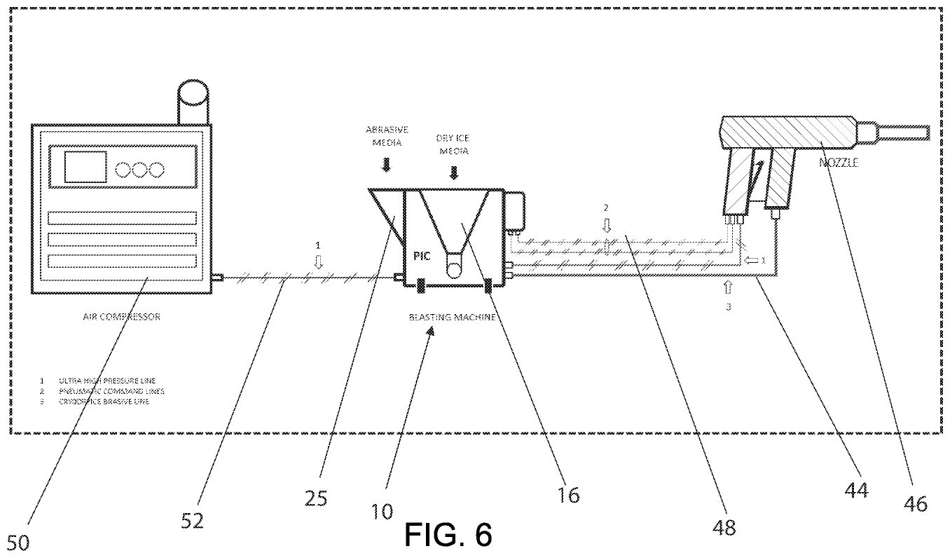

FIGS. 4-6 show schematic views of the various components described above, including the sprayer gun nozzle 46 and the hose 44, as well as pneumatic command lines 48, and the air compressor 50 and a hose or line 52 connecting the air compressor to the housing 12 that is capable of delivering high pressure air to the housing 12.

The system is configured to operate with any type of sprayer gun 46 or nozzle known to those having ordinary skill in the art. For instance, a 1-10 inch nozzle, and more preferably a 3-8 inch nozzle could be used that creates a venturi suction. Nozzles having any other sizes or shapes could be used to create a venturi suction. The present system can efficiently be used to clean systems while minimizing the footprint and amount of space required for the machine. The system is superior in that the mixture of materials is more consistent when it is mixed upstream and delivered to the nozzle using a single air source.

Because of the orientation of the various components, the system 10 advantageously is gravity fed and functions under a venturi suction, and can further encourage mixture of the materials by vibrations in combination with flow valves and a pneumatic and mechanical auger system to create a blasting slurry of the combined medias further downstream in one blasting nozzle utilizing a single trigger component system. The system 10 may have a vibration control system (not shown) that controls when various portions of the system 10 are vibrated to ensure appropriate movement of the materials.

Optimal conditions for the operation of the system 10 will now be described. Preferably, the system 10 will work at a rate of 50-2500 CFM, and more preferably 85-600 CFM. Additionally, the system will work at 10-500 PSI, and more preferably 90-350 PSI. In terms of flow rate, 0.5-100 pounds of material may be pumped per minute. Additionally, as shown, the system 10 is capable of receiving around 50 pounds of dry ice and 50 pounds of abrasive material, although hoppers capable of receiving as little as 0.5 pounds of material, or as much as 1500 pounds of material, and even more preferably between 25-100 pounds of material, could be used. However, as described above, the hopper sizes may vary depending on a number of factors, including the job requirements, as well as the desired weight and bulkiness of the system.

The described system 10 is capable of combining various blasting medias to achieve SP1, SP2, SP3, SP5, SP6, SP7, SP10, SP11, SP13, SP14 surface preparation standards for cleaning and protective coatings. The system is also recognized by Nace standards of Nace 1, 2, 3, 4. 5, 6, and 8.

The present invention also relates to a method of using the cleaning system described above. The method includes the steps of depositing a first material into a first hopper, transferring the material though a hose to a nozzle, and dispelling the material through the nozzle to clean or prepare a surface. The method may also include the steps of depositing a second material into a second hopper and mixing the first material and the second material. The method may also include the steps of activating an auger to mix the materials in a tube and transferring the mixed materials from the tube to a hose. The method may also include the step of moving the mixture using one or more of gravity, a venturi suction, and vibration. The method may also include the step of blasting media that can achieve SP1, SP2, SP3, SP5. SP6, SP7, SP10, SP11, SP13, and SP14 surface preparation standards for cleaning and protective coatings. The method may also include the step of achieving standards of Nace 1, 2, 3, 4, 5, 6, and 8.

While the above description provides a number of potential uses of the two hose cryogenic/abrasive blasting system, it should be noted that there are virtually innumerable uses for the present invention, all of which need not be detailed here. All the disclosed embodiments can be practiced without undue experimentation.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept. In addition, the individual components need not be fabricated from the disclosed materials but could be fabricated from virtually any suitable materials.

Moreover, the individual components need not be formed in the disclosed shapes, or assembled in the disclosed configuration, but could be provided in virtually any shape, and assembled in virtually any configuration to improve the efficiency with which a surface is cleaned by the two hose cryogenic/abrasive blasting system. Furthermore, all the disclosed features of each disclosed embodiment can be combined with, or substituted for, the disclosed features of every other disclosed embodiment except where such features are mutually exclusive.

It is intended that the appended claims cover all such additions, modifications and rearrangements. Expedient embodiments of the present invention are differentiated by the appended claims.

What is claimed is:

1. A cleaning system for mixing a plurality of cleaning materials into a mixture and then spraying the mixture to clean or prepare a surface comprising:
a housing;
at least one hopper contained within the housing;
an air source connected to the housing;
a hose extending from the housing; and
a nozzle attached to the hose.

2. The cleaning system of claim 1, wherein the at least one hopper comprises:
a first hopper configured to receive a cryogenic material; and
a second hopper configured to receive an abrasive media.

3. The cleaning system of claim 2, wherein the first hopper and the second hopper are positioned to mix the cryogenic material and the abrasive media.

4. The cleaning system of claim 3, further comprising a grate located at an entrance of the first hopper;
wherein the grate minimizes clumping of material deposited into the first hopper.

5. The cleaning system of claim 4, further comprising a cover configured to cover the entrance.

6. The cleaning system of claim 3, further comprising a tube configured to mix the cryogenic material and the abrasive media.

7. The cleaning system of claim 6, further comprising an auger extending along at least a portion of the tubing.

8. The cleaning system of claim 7, wherein the hose is attached to the tubing.

9. The cleaning system of claim 3, further comprising at least one vibrator mounted to one of the hoppers.

10. The cleaning system of claim 3, further comprising a plurality of flow valves.

11. The cleaning system of claim 1, further comprising a blasting media that achieves SP1, SP2, SP3, SP5, SP6, SP7, SP10, SP11, SP13, or SP14 surface preparation standards for cleaning and protective coatings.

12. The cleaning system of claim 1, wherein the system is recognized by Nace standards of Nace 1, 2, 3, 4, 5, 6, and 8.

13. The cleaning system of claim 1, wherein the system is gravity fed; and
wherein the system has a venturi suction.

14. A method of using a cleaning system comprising the steps of:
depositing a first material into a first hopper;
transferring the material though a hose to a nozzle; and
dispelling the material though the nozzle to clean or prepare a surface.

15. The method of claim 14, further comprising the steps of:
depositing a second material into a second hopper; and
mixing the first material and the second material.

16. The method of claim 15, further comprising the steps:
activating an auger to mix the materials in a tube; and
transferring the mixed materials from the tube to a hose.

17. The method of claim 16, further comprising the step of moving the mixture using one or more of gravity, a venturi suction, and vibration.

18. The method of claim 15, further comprising the step of blasting media to achieve SP1, SP2, SP3, SP5, SP6, SP7, SP10, SP11, SP13, or SP14 surface preparation standards for cleaning and protective coatings.

19. The method of claim 15, further comprising the step of achieving Nace standards of Nace 1, 3, 4, 5, 6, and 8.

20. A cleaning system comprising:
a housing;
a first hopper located within the housing configured to receive a cryogenic materials;
a second hopper located within the housing configured to receive an abrasive media;
a tube located within the housing and in fluid flow connection to the first hopper and the second hopper, the tube being configured to mix the cryogenic material and the abrasive media;
an air source connected to the housing;
a hose extending from the housing; and
a nozzle attached to the hose.
